(19) United States
(12) Patent Application Publication
(10) Pub. No.: US 2025/0320376 A1
(43) Pub. Date: Oct. 16, 2025

(54) PAINT COMPOSITION FOR INTERNAL PAINTING OF VITREOUS FLASKS AND AUTOMATED AND PARAMETERISED METHOD FOR INTERNAL PAINTING OF VITREOUS FLASKS

(71) Applicant: WHEATON PINTURA E BENEFICIAMENTO DE VIDROS LTDA, Sao Bernardo do Campo (BR)

(72) Inventor: Peter Michael GOTTSCHALK, Sao Bernardo do Campo (BR)

(21) Appl. No.: 18/703,053

(22) PCT Filed: Feb. 27, 2024
(86) PCT No.: PCT/IB2024/051863

§ 371 Date: May 29, 2025

(30) Foreign Application Priority Data
Dec. 11, 2023 (BR) 1020230260667

(51) Int. Cl. C09D 163/00; B65D 1/09; C09D 4/00; C09D 133/04

(52) U.S. Cl. CPC C09D 163/00; B65D 1/09; C09D 4/00; C09D 133/04

(57) ABSTRACT

This is a paint composition for the internal painting of vitreous flasks and an automated and parameterized method for the internal painting of these vitreous flasks belonging to the perfumery, cosmetics, pharmaceutical and food segments. The main components of this paint composition for the internal painting of vitreous flasks are, natural water-based varnish or synthetic water-based varnish, pigment, catalyst and additive, the combination of which with the perfected automated and parameterized method for the internal painting of vitreous flasks makes it possible to create unique visual effects, distinguishing these painted flasks from conventional ones on the market.

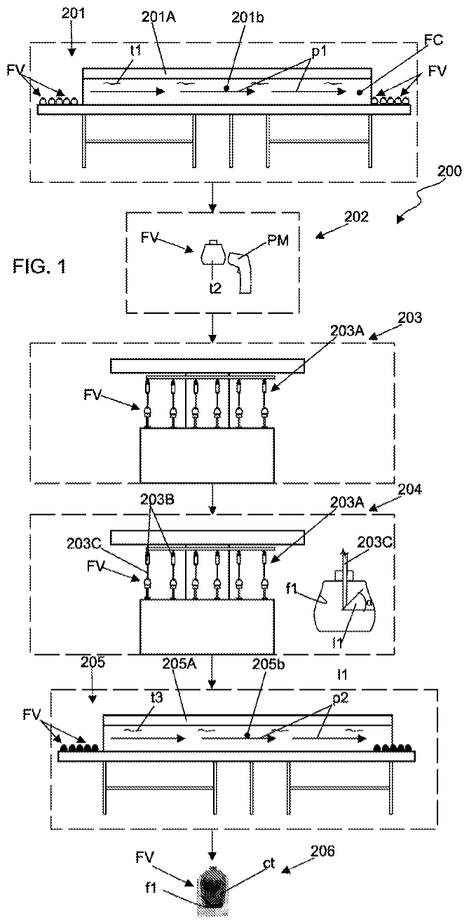

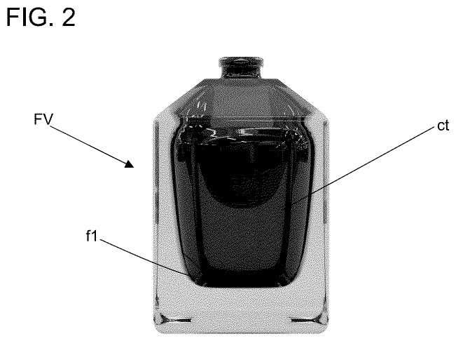

### TECHNICAL FIELD OF THE INVENTION

The present invention patent deals with a paint composition for painting the inside of vitreous flasks and an automated and parameterized method for painting the inside of these vitreous flasks belonging to the perfumery, cosmetics, pharmaceutical and food segments.

The main components of the innovative paint composition for painting the inside of vitreous flasks are natural water-based varnish or synthetic water-based varnish, pigment, catalyst and additive which, combined with the automated and parameterized method based on the control of (i) the preheating temperature of the vitreous flask; (ii) the surface temperature of the vitreous flask; (iii) the angle of the paint spraying fan and (iv) the curing temperature, enables the paint composition in question to be applied superficially to the entire internal area of the vitreous flask, as well as the polymerization of said paint by means of the catalysis reaction, adhering fully to this surface without interfering with the product to be packaged.

The combination of the innovative composition with the improved automated and parameterized method for painting the inside of vitreous flasks makes it possible to create unique visual effects, which is the result of the invention now claimed by the Applicant, and which distinguishes these painted flasks from conventional ones on the market.

### HISTORY OF THE INVENTION

The flasks or glass packaging is used in various sectors such as the food industry to store a variety of foods, including beverages, sauces, preserves, and sweets. Glass is an inert material that does not react with food. Additionally, in the cosmetics sector, glass containers are used to store a variety of products, including perfumes, creams, and lotions. The pharmaceutical sector also uses vitreous flasks to store various types of medications and other pharmaceutical products, benefiting from the inert properties of glass.

It is well known that the industry often seeks to present distinctive vitreous flasks, creating new models for the market. In order to meet the new demands of the perfumery, cosmetics, pharmaceutical and food industries, the technologies applied to the compositions and methods of coloring the inside of glass packaging and flasks must be renewed. One of the best-known technologies is that which applies paint to the inside surface of these flasks, allowing the packaging to be distinctive and sophisticated. This is because internal painting can be used to create a variety of visual effects, from solid colors to complex patterns.

### ANALYSING THE STATE OF THE ART

By way of example, document No. FR 2939614 discloses a process for decorating a transparent or translucent flask made of plastic or glass material, intended for cosmetic use, to contain a perfume-type liquid or similar, the decoration of which is carried out on the inside of the flask, and which consists of producing at least one layer of paint or varnish on the inside surface of the flask by spraying a mist in the form of a powder or liquid onto the inside of the flask. The layer of decorative varnish is produced by spraying the inside of the flask with a colored liquid, directly onto the flask (or plastic in the case of a plastic flask), using a low-pressure pneumatic gun that includes an extension that can be inserted inside the flask, carrying a spray nozzle at its end, and during spraying the spray nozzle is moved vertically and rotates on itself to deposit a homogeneous layer of varnish. It should also be noted that at the same time as spraying, suction is carried out to create a vacuum inside the flask. Spraying is carried out in a hot flask, so the flask is heated prior to spraying. Heating can be done, for example, by hot air or by passing it through an oven, for example for 7 minutes at 170°, to carry out a type of cooking.

The Applicant, active in the field and specializing in the production of glass packaging for the perfumery and cosmetics, pharmaceutical and food segments, is the depositor of document no. BR102019003937.0 which deals with a method for painting the inside of glass packaging for the perfumery and cosmetics market comprising the following steps (i) Inserting the flasks into a heating system (oven/stove/infrared oven); (ii) Heating the weak; (ii) Positioning the heated weak in the painting equipment; (ill) Painting the inside of the flasks; (iv) Inserting the flasks into the curing oven; (v) Curing the flasks.

After analyzing the above-mentioned request, documents of particular relevance were found, which were assessed and refuted by means of a comparison and, by way of further clarification, one of the documents revealed in the research is No. U.S. Pat. No. 8,746,166 which deals more specifically with a device, spray nozzle and orifice, associated with the translational movement of the support as a function of the distance from the internal surface of the flask (horizontal, vertical movements and 360° rotation). The description is particularly aimed at constructively defining the device and its functional operations for applying the following coating materials: lacquer, sol-gel solution, metallic solution, solutions consisting of organometallic resins, varnish and paint.

Another document No. US2015060444 discloses applying to the sun-jelly solution comprising a polysilazane and an organic solvent to an outer surface of a glass container to form a sun-jelly coating thereon, and heating the glass container and the sol-gel coating in an environment containing water vapor at a temperature of between 150° C. and 600° C. to form an inorganic silica coating on the outer surface of the glass container, wherein the silica coating has a hardness of more than 8.5 GPa and is bonded to the outer surface of the glass container by means of a plurality of siloxane bonds. This process is intended for the application of an external coating and differs greatly from the object in question and the applicant's previous application, as mentioned above.

Another prior art document related to the composition of paint for the internal painting of vitreous flasks and the method for internally painting these vitreous flasks is document No. CN116237216, which discusses the process of spraying cosmetic vitreous flasks with gradient color. According to the technical purpose, the spraying process of cosmetic vitreous flasks with gradient colors can automatically adjust the spraying distance. A method for manufacturing the process of spraying cosmetic vitreous flasks with gradient color comprises the following steps: color gradient selection and color matching are conducted, specifically, 2-3 similar colors are selected for matching according to the cosmetic brand's color series; and primer spraying, where cosmetic vitreous flasks are fixed to a conveyor platform, and the cosmetic vitreous flasks are transported to a spraying area through the transport platform. A distance sensor is adopted to detect the distance between the bodies of cosmetic vitreous flasks to determine whether the spraying distance falls within a reasonable range or not, so that the position of the paint spray gun is controlled, the spraying distance can be automatically adjusted and controlled, and the device is suitable for cosmetic vitreous flask bodies of different sizes; thus, the accuracy of distance regulation and control and the spraying effect can be improved.

Document No. CN111892845 uses cold paint for the vitreous flask manufacturing industry and belongs to the technical field of lubricating paint. The ink is an emulsion product and is an oil-in-water emulsion prepared primarily from water serving as a dispersion medium, polyethylene wax serving as a lubricating material, acrylic resin serving as a film-forming agent and a non-ionic surfactant serving as an emulsifier. The product is made up of the following components in percentage by mass: 40 to 50 percent dispersion medium, 35 to 45 percent lubricating material emulsion, 5 to 10 percent film-forming agent, 3 to 7 percent emulsifying agent and 3 to 7 percent emulsifying agent. 5% antifreeze agent.

Other documents are part of the state of the art, but the Applicant, in order to extend the technical effects of painting the inside of vitreous flasks, presents in this application a paint composition for painting the inside of vitreous flasks and an improved automated and parameterized method for painting the inside of these vitreous flasks which, when combined with the design of the flask, provides the creation of unique and sophisticated visual effects that set them apart from the usual technology and, consequently, from the products on the market.

Thus, it is a fact that the documents cited in the paragraphs above, despite belonging to the same field of application, do not present any of the characteristics of the object now perfected, thus ensuring that it meets the legal requirements for patentability.

### AIMS OF THE INVENTION

It is therefore the aim of this invention to present an innovative ink composition that uses a water-based varnish that enables full adherence to the inner surface of the vitreous flask which, by means of a catalysis reaction, polymerizes on the inside of the flask, forming a thin layer that does not interfere with the properties of the product to be packaged, such as color, consistency, odor, volatility and fixation.

It is also the aim of this invention to present an innovative ink composition that uses water-based varnish which, combined with the design of the vitreous flasks, provides a three-dimensional visual effect, as well as expanding the possibilities for customization when combined with other external painting techniques such as screen printing, hot stamping, painting, digital printing and others.

Another aim of this invention is to present an innovative paint composition using water based varnish whose use of a dark color palette provides a closed finish and luxurious effect.

It is also the aim of this invention to present an automated and parameterized method for the internal painting of vitreous flasks as a result of the improvement of application No. BR102019003937-0 of the same Applicant, since the composition now innovated has promoted a rigorous mapping of the method, as well as carrying out chemical and quality tests, configuring an evolution of the production process, from the application of the paint to its curing and firing to obtain a better solution for vitreous flasks with internal painting presented on the market.

### DESCRIPTION OF THE IMAGES

To complement the present description, in order to obtain a better understanding of the characteristics of the present invention and in accordance with a preferential practical realization of the same, a set of drawings is attached to the description, in which, in an exemplary but non-limiting manner, the following has been represented:

image 1 shows a schematic representation of the stages that make up the automated and parameterized method for the internal painting of vitreous flasks; and

image 2 is a photographic image of a model of a vitreous flask with the inside painted.

### DESCRIPTION OF THE INVENTION

The present invention patent relates to the “COMPOSITION OF PAINT FOR INTERNAL PAINTING OF VITREOUS FLASKS AND AUTOMATED AND PARAMETRISED METHOD FOR INTERNAL PAINTING OF VITREOUS FLASKS”, more precisely the composition of paint and method (100) for internal painting of vitreous flasks (VF) used in the perfumery, cosmetics, pharmaceutical and food segments. Said method (200) consists of the improvement of document No. BR102019003937-0 of the same Applicant and which, in turn, presents the steps (i) inserting the flasks into a heating system (oven/greenhouse/infrared oven); (ii) heating the flasks; (iii) positioning the heated flasks in the painting equipment; (iv) painting the inside of the flasks; (v) inserting the flasks into the curing oven; (vi) curing the flasks.

The composition of the present invention comprises the ingredients: (i) epoxy water-based varnish or acrylic water-based varnish; (ii) catalyst; (iii) additive; (iv) pigment. Having described the ingredients, it should be understood that the quantities for determining the properties of the paint composition for internal painting of vitreous flasks (VF) are shown in tables 1 and 2.

TABLE 1
Composition ‘A’ for internal painting of vitreous flasks (VF).

| Components of composition ‘A’ | Percentage |
|---|---|
| Epoxy or acrylic water-based varnish | 50 to 90% |
| Catalyst | 0.5 to 4% |
| Additive | 10 to 15% |

TABLE 2
Composition ‘B’ for painting the inside of vitreous
flasks (VF) with pigment in dark tones.

| Components of composition ‘B’ | Percentage |
|---|---|
| Epoxy or acrylic water-based varnish | 75 to 82% |
| Catalyst | 1 to 2% |
| Additive | 1 to 2% |
| Black pigment | 4 to 6% |

The catalyst can be of the silane type, giving the film greater chemical resistance.

In order to optimize the adherence of the paint described above to the inner surface (f1) of the vitreous flask (VF), automated and parameterized stages of the innovative method (200) are envisaged, namely:
Step (201)—Heating the flask (VF) in a preheating oven (201A) and time (p1) for the flask (VF) to pass through a tunnel (201b) with displacement over a period of 38 to 40 minutes where the oven (210A) has a temperature of 110° C. on average with a variation of up to 10° C.;
Step (202)—Checking the surface temperature (t2) of the flask (VF) at the end of the stroke (FC) using a pyrometer (PM);
Step (203)· Immediate feeding of the preheated flask (VF) into the painting device (203A), which at this point should have an ideal surface temperature (t2) of between 65° C. and 80° C.;
Step (204)—Applying the paint to the inside surface (f1) of the vitreous flask (VF) using guns (203B) with needles (203C) positioned to apply the paint jet using a fan (I1) at an angle (α) of 45°;
Stage (205)—Curing the flasks (VF) positioned on a gas oven conveyor belt (205A) whose time (p2) for the flasks (VF) to pass through the tunnel (205b) includes travelling for 45 to 50 minutes at a temperature (t3) averaging 240° C. with a variation of up to 10° C.;
Stage (206)—Final quality check of the flasks (VF) with internal surface (f1) coated with paint (ct) by placing them in packaging (not shown) for transport.

The internal coating on the surface (f1) of the vitreous flask obtained (VF) comprises a polymeric layer (ct) which does not influence the condition of the packaged product.

It is true that when the present invention is put into practice, modifications may be introduced with regard to certain details, without this implying a departure from the fundamental principles that are clearly substantiated in the claim framework, it being understood that the terminology used was not intended as a limitation.

1. “PAINT COMPOSITION FOR INTERNAL PAINTING OF VITREOUS FLASKS”, more precisely, it is a paint composition for the internal painting of vitreous flasks (VF) used in the perfumery, cosmetics, pharmaceutical and food segments; characterized by the composition comprising epoxy water-based or acrylic water-based varnish; catalyst; additive; pigment.

2. “PAINT COMPOSITION FOR INTERNAL PAINTING OF VITREOUS FLASKS”, according to claim 1, characterized in that the quantification of the composition comprises from 50 to 90% epoxy water-based varnish or acrylic water-based varnish; from 0.5 to 4% catalyst; 10 to 15% additive.

3. “PAINT COMPOSITION FOR INTERNAL PAINTING OF VITREOUS FLASKS”, according to claim 1, characterized in that the composition for internal painting of vitreous flasks (VF) with pigment in dark tones comprises the quantification of 75 to 82% epoxy water-based or acrylic water-based varnish; 1 to 2% catalyst; 1 to 2% additive; 4 to 6% black pigment.

4. “PAINT COMPOSITION FOR INTERNAL PAINTING OF VITREOUS FLASKS”, according to claims 1, 2 and 3, characterized in that the catalyst is of the silane type.

5. “AUTOMATED AND PARAMETERISED METHOD FOR THE INTERNAL PAINTING OF VITREOUS FLASKS”, according to any of claims 1 to 3, characterized in that the method (200) for predicting:
stage (201)—heating the flask (VF) in a preheating oven (201A), where the time (p1) taken for the flask (VF) to pass through the tunnel (201b) is 38 to 40 minutes, where the oven (210A) reaches a temperature (t1) of 110° C. on average, with variations of up to 10° C.;
step (202)—checking the surface temperature (t2) of the flask (VF) at the end of the stroke (FC) using a pyrometer (PM);
step (203)—immediate feeding of the preheated flask (VF) into the painting device (203A); the flask (VF) with a minimum surface temperature (t2) of between 65° C. to 80° C.;
step (204)—application of the paint to the inner surface (f1) of the vitreous flask (VF) using guns (203B) with needles (203C) in a fan (I1) inkjet application with an angle (α) of 45°;
stage (205)—curing of the flasks (VF) positioned on a gas oven conveyor belt (205A) with a tunnel (205b), with the flasks (VF) travelling for 45 to 50 minutes (p2) at a temperature (t3) averaging 240° C. with a variation of up to 10° C.
